(19) United States
(12) Patent Application Publication
(10) Pub. No.: US 2011/0241427 A1
(43) Pub. Date: Oct. 6, 2011

(54) PORTABLE ELECTRONIC DEVICE

(75) Inventor: JIN-MIN HE, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/942,159

(22) Filed: Nov. 9, 2010

(30) Foreign Application Priority Data
Mar. 31, 2010 (CN) 201010137017.3

(51) Int. Cl. H02J 9/04

(52) U.S. Cl. 307/66

(57) ABSTRACT

A portable electronic device includes a transformer unit, a power transmission unit electrically connected to the transformer unit, a rechargeable battery electrically connected to the power transmission unit; and an inner circuitry electrically connected to both the power transmission unit and the battery. The transformer unit regulates a voltage provided by an exterior power supply to a predetermined value, and the power transmission unit receives the regulated voltage and selectively transmits the regulated voltage to the battery or to the inner circuitry according to the value of the regulated voltage.

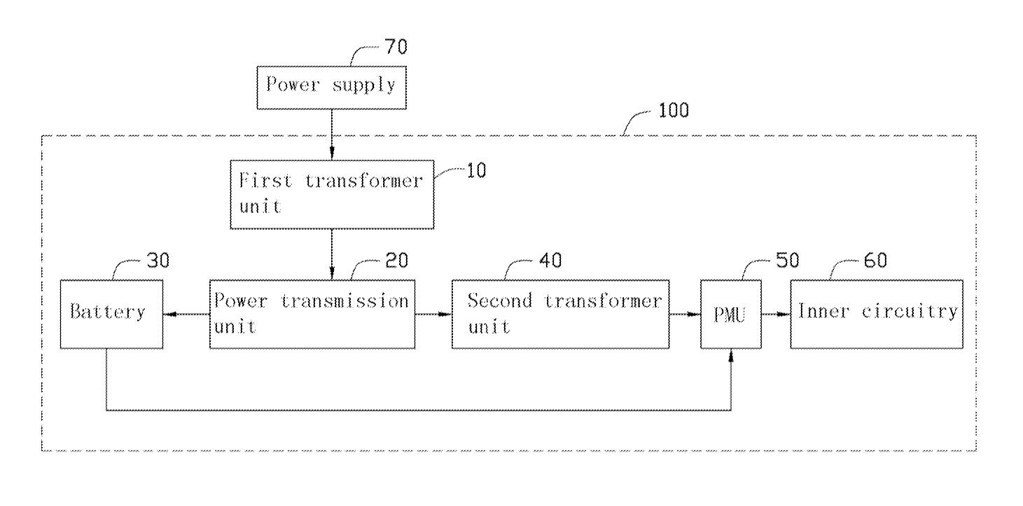

### BACKGROUND

1. Technical Field

The present disclosure relates to portable electronic devices, and particularly to a portable electronic device capable of protecting batteries of the portable electronic device.

2. Description of Related Art

Rechargeable batteries are widely used in portable electronic devices, such as mobile phones, personal digital assistants (PDA), and notebook computers. When electric power of a rechargeable battery used in portable electronic device is exhausted, the portable electronic device with the battery can be electrically connected to other power supplies to recharge the battery. However, if the portable electronic device is used during the recharging process, the battery will synchronously receive electric power from another power supply and output electric power to the portable electronic device. The electric power input and output process synchronously applied thereto may damage the battery.

Therefore, there is room for improvement within the art.

### BRIEF DESCRIPTION OF THE DRAWINGS

Many aspects of the present portable electronic device can be better understood with reference to the following drawings. The components in the various drawings are not necessarily drawn to scale, the emphasis instead being placed upon clearly illustrating the principles of the present portable electronic device. Moreover, in the drawings, like reference numerals designate corresponding parts throughout the figures.

The drawing is a block diagram of a portable electronic device, according to an exemplary embodiment.

### DETAILED DESCRIPTION

The drawing shows a portable electronic device 100, according to an exemplary embodiment. The portable electronic device 100 can be a mobile phone, a personal digital assistant (PDA), or a notebook computer, for example. The portable electronic device 100 includes a first transformer unit 10, a power transmission unit 20, a rechargeable battery 30, a second transformer unit 40, a power management unit (PMU) 50, and an inner circuitry 60. The inner circuitry 60 can have conventional functions of a mobile phone, a PDA, or a notebook computer, such as communication and input/output functions. The first transformer unit 10, the power transmission unit 20, the second transformer unit 40, the PMU 50, and the inner circuitry 60 are electrically connected in series. The battery 30 is further electrically connected to the power transmission unit 20 and the PMU 50. When the portable electronic device 100 is not electrically connected to an exterior power supply, only a voltage of the battery 30 is applied to the PMU 50, and thus the PMU 50 transmits electric power of the battery 30 to the inner circuitry 60 to drive the inner circuitry 60 to function. If an exterior power supply 70, such as a socket, is electrically connected to the first transformer unit 10, the PMU 50 can detect a voltage of the power supply 70 through the first transformer unit 10, the power transmission unit 20, and the second transformer unit 40, and thus prevents the battery 70 from outputting electric power to the inner circuitry 60.

In addition to having the common working mode of using the battery 30 to supply electric power to the inner circuitry 60, the portable electronic device 100 has a special working mode and a recharging mode. Referring to the FIGURE, in either of the two modes, the first transformer 10 is electrically connected to the exterior power supply 70 to receive a voltage input to the portable electronic device by the power supply 70, and regulates the voltage provided by the power supply 70 to a predetermined voltage value. The power transmission unit 20 receives the regulated voltage, and the PMU 50 detects the regulated voltage by the power transmission unit 20 and the second transformer unit 40. Upon detecting the voltage of the power supply 70, the PMU 50 prevents the battery 30 from outputting electric power to the inner circuitry 60. Furthermore, the power transmission unit 20 detects the value of the regulated voltage. According to the detected value of the regulated voltage, the power transmission unit 20 selectively transmits the voltage to the battery 30 for recharging the battery 30 or to the second transformer unit 40 for directly driving the inner circuitry 60 to function. The two modes can be selected and switched by connecting other power supplies to different connectors (not shown) of the first transformer unit 10, or by operating a switch (not shown) electrically connected to the first transformer unit 10.

In the special working mode, the first transformer unit 10 regulates the voltage provided by the power supply 70 to a first value (for example, about 3.7V, which is a rated working voltage of most mobile phones), and inputs the regulated voltage to the power transmission unit 20. Upon receiving the voltage regulated to the first value, the power transmission unit 20 detects the value of the voltage and then transmits the voltage to the second transformer unit 40. The second transformer unit 40 further regulates the voltage to precise working voltage values of the inner circuitry 60. The PMU 50 transmits the voltage regulated by the second transformer unit 40 to the inner circuitry 60 to drive the inner circuitry 60 to function. Thus, electric power of the power supply 70 is provided to the inner circuitry 60, without passing through the battery 30.

In the recharging mode, the first transformer unit 10 regulates the voltage provided by the power supply 70 to a second value (for example, about 4.2V, which is a rated recharging voltage of most mobile phones). Upon receiving the voltage regulated to the second value, the power transmission unit 20 detects the value of the voltage and then transmits the voltage to the battery 30 to recharge the battery 30.

When the portable electronic device 100 is electrically connected to the power supply 70, electric power is input to the portable electronic device 100 by the power supply 70 and can be selectively used to recharge the battery 13 or drive the inner circuitry 60 to function. When the battery 30 is being recharged or the electric power of the power supply 70 is used to drive the inner circuitry 60 to function, the battery 30 is prevented from outputting electric power to the inner circuitry 60 by the PMU 50. Compared with batteries of conventional portable electronic devices, the battery 30 is prevented from synchronously receiving electric power from the power supply 70 and outputting electric power to the inner circuitry 60. Thus, the battery 30 can have a longer life-span.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A portable electronic device, comprising:
a transformer unit;
a power transmission unit electrically connected to the transformer unit;
a rechargeable battery electrically connected to the power transmission unit; and
inner circuitry electrically connected to both the power transmission unit and the battery; wherein the transformer unit regulates a voltage provided by an exterior power supply to a predetermined value, and the power transmission unit receives the regulated voltage and selectively transmits the regulated voltage to the battery or to the inner circuitry according to the value of the regulated voltage.

2. The portable electronic device as claimed in claim 1, wherein when the transformer unit regulates the voltage of the exterior power supply to a first value, the power transmission unit transmits the regulated voltage to the circuitry.

3. The portable electronic device as claimed in claim 2, wherein when the transformer unit regulates the voltage of the exterior power supply to a second value, the power transmission unit transmits the regulated voltage to the battery for recharging the battery.

4. The portable electronic device as claimed in claim 3, further comprising a power management unit (PMU) electrically connected to the transformer unit and the battery; the PMU detecting voltages input to the transformer unit; when no voltage is input to the first transformer unit and detected by the PMU, and the PMU transmits electric power of the battery to the inner circuitry to drive the inner circuitry to function; when detecting an voltage input to the first transformer unit, the PMU prevents the battery from outputting electric power to the inner circuitry.

5. The portable electronic device as claimed in claim 4, wherein the power transmission unit is electrically connected to the inner circuitry via the PMU; when the transformer unit regulates the voltage of the exterior power supply to the first value, the power transmission unit transmits the voltage to the circuitry via the PMU for driving the inner circuitry to function.

6. The portable electronic device as claimed in claim 5, further comprising another transformer unit, the power transmission unit electrically connected to the PMU via the another transformer unit, wherein the another transformer unit regulates voltage transmitted from the power transmission unit to working voltage values of the inner circuitry, and the PMU transmits the voltage regulated by the another transformer unit to the inner circuitry to drive the inner circuitry to function.

7. The portable electronic device as claimed in claim 6, wherein the PMU is electrically connected to the transformer unit via the power transmission unit, and the another transformer unit, and detects the voltage of the exterior power supply through the transformer unit, the power transmission unit, and the another transformer unit.
